(19) United States
(12) Patent Application Publication
(10) Pub. No.: US 2021/0301784 A1
(43) Pub. Date: Sep. 30, 2021

(54) AN INTEGRATED AND SYNERGISTIC MULTI-TURBINE, MULTI-VANE ARRAY FOR A MODULAR, AMPLIFIED WIND POWER GENERATION SYSTEM

(71) Applicant: V3 Technologies, LLC, Fisco, TX (US)

(72) Inventor: Kenneth D. CORY, Ph.D., Frisco, TX (US)

(21) Appl. No.: 17/268,287

(22) PCT Filed: Jan. 10, 2020
(86) PCT No.: PCT/US2020/013180

§ 371 Date: Feb. 12, 2021

Related U.S. Application Data
(60) Provisional application No. 62/792,807, filed on Jan. 15, 2019.

(51) Int. Cl. F03D 3/02; F03D 3/00; F03D 15/00; F03D 9/25; F03D 7/06; H02P 9/06; H02K 7/18

(52) U.S. Cl. CPC F03D 3/02; F03D 3/005; F03D 15/00; F03D 9/25; F03D 7/06; H02P 2101/15; H02K 7/183; F05B 2220/706; F05B 2270/327; F05B 2240/94; H02P 9/06

(57) ABSTRACT

A large-scale, modular, wind power generating structure and system involving a toroidal or ovoidal shaped wind amplification structure/module that can be stacked vertically to form a tower that passively accelerates a wind flow that moves around each of the modules due to the Bernoulli Principle. Each amplification level includes a plurality of vertical axis wind turbine and generator assemblies, fairings, and vanes that form a synergistic system wherein the efficiency of the vertical axis turbine and generator assemblies and the amount of energy that can be produced per module are substantially improved compared to the turbine assemblies operating outside the integrated and amplified wind system.

### CROSS-REFERENCE

This application is a 371 Application of PCT/US2020/013180 filed Jan. 10, 2020, which claims priority to U.S. Provisional Patent Application No. 62/792,807 filed Jan. 15, 2019, which is incorporated in its entirety herein by reference.

### FIELD OF THE TECHNOLOGY

The present application relates generally to electrical power generation and, more specifically, to an apparatus and method for generating electrical power from wind.

### BACKGROUND

Over the last few decades, the price volatility of fossil fuels plus the political instability of oil-producing regions have intensified efforts to develop alternative energy sources that are progressively more clean, efficient, reliable, and have a smaller footprint of land. Wind-driven power generation systems have been of particular interest, in part, because they are currently one of the most economically competitive forms of large-scale renewable power. In general, the term “wind-driven power” is referring to the process whereby a wind stream is converted to electrical power using a rotor/turbine assembly, either horizontally or vertically oriented to the flow of the ambient wind. The rotor blades of the turbine assembly convert the energy of the moving air into rotational motion on a drive shaft of the turbine assembly. An electrical generator coupled to the drive shaft then converts the rotational motion into electrical power.

However, conventional wind-driven power generation systems suffer from many challenges. The term conventional is meant generally herein to describe a system that comprises a monopole tower with a single multi-bladed rotor spinning about an axis that is horizontal to the ambient flow of wind and is located at or near the top of the tower, i.e., a Horizontal Axis Wind Turbine or “HAWT” system. In general, conventional wind power generators operate only when the wind blows above a certain minimum velocity, only within a certain range of wind velocities, and at a maximum power output level for an even smaller range of wind velocities. They also have a history of endangering birds and making significant and detrimental infrasonic pulsing noises. As a result, wind power generation has traditionally been expensive to produce and not reliably available. In response, conventional wind turbine manufacturers' assemblies have evolved towards very large rotor assemblies—with rotor diameters often equal to or greater than 125 meters—and very tall towers in order to gain at least some economies of scale and to reach higher velocity and steadier winds that occur at higher altitudes.

Ironically, increases in the sizes of conventional rotor diameters have led to a number of additional problems. Large rotors are much more difficult to manufacture because the size of each blade reduces the ability for mass production and because the forces on the blade require special and expensive materials. Delivery of large rotors to the generation site is also a severe problem which often requires specialized trucking systems, assistance clearing crowded roadways, and wider/longer access ways near the wind farm which are often not feasible given the wind farm's remote location and position on hillsides. Maintenance is a challenge given the inability to quickly and easily access damaged components and the inability to deliver replacement components quickly. In addition, large rotors create greater torque and balance problems on the nacelle hub which often requires stronger gear box assemblies comprised of exotic alloy compositions.

Another well-known problem of traditional turbines is the footprint such a technology requires. Wind turbines require smooth wind for maximum conversion efficiency. Turbulence from adjacent turbines forces towers to be spread across great distances to allow winds to recover optimal wind properties. The larger the rotors, the longer the wake of turbulence, and the fewer the number of towers that can be placed on a given wind farm acreage. Additionally, operational efficiency is diminished due to the inability of such large rotors to effectively accommodate heterogeneous wind conditions at different altitudes across the rotor's face. In other words, it is difficult for a single large rotor to handle winds that come from different directions and/or at different speeds within the diameter of the single rotor.

Alternatively, an augmented wind power generation system uses a funneling or diversion surface, for example a full or partial shroud, fairing (nose cone), and/or vanes adjacent to a turbine, to passively increase the velocity of the ambient wind—based on a principle of physics known as the “Bernoulli Effect”—across the rotor blades. Because we know from the “Wind Power Equation” that the electrical energy generated from a wind turbine is, in part, a cubic function of the speed of the wind, an augmented wind generation system has proven to substantially increase the amount of power generated from a given size wind turbine. Although there are many possible configurations of this, the shroud, funnel, fairing, and vane structures may be vertically stacked into a tower with one or more turbine assemblies located adjacent to the wind amplification surfaces. There are numerous types of wind amplification devices, but some are described in U.S. Pat. No. 4,156,579 (Weisbrich), U.S. Pat. No. 4,288,199 (Weisbrich), U.S. Pat. No. 4,332,518 (Weisbrich), U.S. Pat. No. 4,540,333 (Weisbrich), U.S. Pat. No. 5,520,505 (Weisbrich), U.S. Pat. No. 7,679,207 (Cory), and U.S. Pat. No. 9,127,646 (Cory). All seven of the above patents are hereby incorporated by reference as if fully set forth herein.

Specific benefits of the exemplary embodiments are expanded upon later, but in general the use of smaller rotors to produce an equivalent amount of energy to larger rotors produces numerous advantages for augmented systems over conventional wind turbine systems. First, smaller turbines are easier to mass produce and easier to transport to the wind farm site. Second, smaller rotor diameters require a smaller diameter of wind flow to operate which reduces the inefficiencies of having heterogeneous wind conditions at different altitudes. Third, “cut in” speeds, the speed at which a turbine begins to generate electricity, are lower because the smaller blades are usually lighter and more able to operate in lower wind conditions. Fourth, the footprint of towers with smaller rotors is significantly improved because the size of the turbulence wake is shorter, and towers can be placed much closer together. Fifth, the torque impact on the hub gears is significantly lessened thereby reducing the need for heavier engineering and exotic materials. And sixth, the smaller rotors spinning at higher speeds located next to a partial or full shroud, fairing, or vane provide the visual signals needed for birds to avoid the path of the rotor blades thereby reducing accidental bird kill often found with traditional tower systems.

However, not all augmented systems offer equal benefits. Some augmented systems are still not optimized to fully maximize wind amplification efficiently or to do so in an economically ideal manner. An illustrative example would include a recent system described in U.S. Pat. No. 7,679,209. This tower utilizes a single, cylindrical core to create marginal wind amplification and a series of cylindrical rotors on only two shafts adjacent to the one core to convert wind energy into electrical energy.

This configuration is not optimal for energy conversion in an economically attractive way for a variety of reasons. First, unlike a toroidal shaped tower the single cylindrical tower only deflects wind in one direction (laterally) thereby providing only marginal increases in wind speed. In other words, a much greater amount of wind is captured and funneled in a more efficient way in a toroidal tower leading to higher volumes of faster wind streams. Second, the cylindrical rotor assembly is only a small portion of the overall tower silhouette leading to unnecessary tower costs and additional loss of potential wind energy on a given wind farm. Third, the single open cylinder exposes key components to the elements leading to unnecessary and expensive maintenance costs. Fourth, the rotors are connected to only two rotating shafts meaning that there are relatively few (two) generators for the whole apparatus which thereby restricts the tower's generating capacity. Fifth, because there are only two vertical shafts for the entire tower it is unable to have rotors automatically face the direction of the wind flow at different altitudes which again reduces the tower's applicability in larger sizes as well as its economic efficiency. Although an interesting idea for enhancing ambient wind speeds, the systems described in U.S. Pat. No. 7,679,209 and others like it fail to effectively compete with conventional large-scale turbine systems or with the embodiments described herein.

One system that has withstood the test of time because of the potential of its unique attributes is the toroidal shaped wind tower introduced in U.S. Pat. No. 4,156,579 (Weisbrich) and expanded upon in U.S. Pat. No. 5,520,505 (Weisbrich), U.S. Pat. No. 7,679,207 (Cory), and U.S. Pat. No. 9,127,646 (Cory). This configuration uses a series of vertically stackable, partially shrouded tower modules to direct wind over a pair of turbine systems located within the hollows of each module.

There are numerous benefits of this configuration. First, substantial research of the toroidal shape by numerous engineering experts has demonstrated the efficiency of this configuration due to a substantial increase in wind speed, especially nearest the sides of the core tower. The unique shape allows for a large volume of wind to be funneled from three sides (top, bottom, and laterally), not just one, towards the turbines in the hollows of the tower. Second, the turbine pairs operate independently from turbines on other levels which allow each set of turbines to face directly into the wind at its particular altitude. Third, because each pair is independent from other pairs, the tower can produce a portion of its overall capacity when wind conditions and maintenance activities warrant. For example, if the wind is moving sufficiently fast to generate power at the level of the higher modules but not at the lower modules, the higher module turbines can still operate and produce electricity thereby increasing the tower's overall “capacity factor”—i.e., actual energy output per year compared to the potential maximum. Partial production is also a significant advantage to reduce maintenance costs because the tower can still produce some power while a subset of turbines is being fixed. A conventional wind turbine needs a sufficient average wind flow across its entire, large diameter area to generate any power at all leading to an all or nothing output of electricity. Partial production is an advantage for the toroidal tower configuration over traditional towers and over other amplified systems such as those found in U.S. Pat. No. 7,679,209. Fourth, the toroidal tower configuration is also scalable allowing the generation of power in the multi-megawatt scale. And fifth, the toroidal tower allows multiple turbines to be accessed and maintained on a single tower reducing maintenance costs for large-scale towers. These benefits are in addition to the general advantages of augmented systems described above such as smaller footprint, lower cut in speeds, reduced gear box requirements, lower cost from mass production, and reduced bird kill.

Although the toroidal configuration has some clear advantages even over other augmented systems, its success in being effectively commercialized has still been limited to date. A key factor constraining the adoption of the technology thus far has been the inability to manufacture a rotor and generator system to fully capitalize on the unique “Horizontal Wind Shear” flow pattern purposefully created by the toroidal tower. As illustrated in FIG. 1, a horizontal wind shear exists due to the Bernoulli Effect wherein the speed of the wind nearest the shell of the toroidal tower is traveling faster than the wind located further away from the tower. In other words, the further from the tower the wind flow is located, the lower the amplification effect and therefore the lower the wind speed. To date, engineers have relied on using traditional HAWT turbines on toroidal towers, but these turbines are severely hampered by the strong horizontal wind shear environment. Specifically, the blades of the HAWT rotor travel perpendicularly through the horizontal wind shear such that the tip of the blade nearest the tower is receiving a much greater force of wind than the rest of the blade or those blades further from the tower. These factors create differential torque on the individual blades and the overall turbine causing significant decreases in efficiency and increases in turbine malfunctions/failures.

The embodiments described in U.S. Pat. No. 9,127,646 (Cory) provided a unique combination of adaptations to a traditional Vertical Axis Wind Turbine (“VAWT”) and generator configuration that specifically accommodated a horizontal wind shear flow pattern and optimized the benefits of a multilevel toroidal-shaped tower (or a tower shape that produces a similar wind amplification condition) towards the goal of cost effective, large-scale power production.

VAWT systems are a type of wind turbine where the main rotor shaft is vertical instead of horizontal to the ambient flow of the wind. Well established advantages of VAWT turbines over HAWT turbines tend to include omni-directional operation (can simultaneously accept wind from any direction), low noise, and excellent durability even in turbulent wind conditions. Traditional disadvantages of VAWTs have included lower conversion efficiencies and a pulsatory torque that is produced during each revolution. Later approaches solved the torque issue by using a helical twist of the rotor blades. In addition, because VAWT turbines have traditionally been more difficult to mount on a monopole tower they are often installed nearer to a base or the ground which typically results in access to lower speeds and more turbulent winds.

A subset of the VAWT family of wind generators is the Savonius system. A Savonius VAWT system is a “drag” type of device with two (or more) scooped blades like those used in anemometers. Savonius VAWT wind turbines spin because there is a differential in pressure between the convex and concave side of the cupped blade. Alternatively, a Darrieus form of VAWT consists of a number of curved airfoil blades mounted at the top and bottom of a vertical shaft or axis. Similar to an airplane wing, wind traveling over the airfoil blades creates a condition of “lift” which accelerates the rotors around the vertical axis. In a horizontal wind shear environment—such as that which is created in a toroidal wind tower—a VAWT turbine would benefit by the differential speeds of the funneled wind in that the faster winds near the tower would be impacting all or most of a single blade while the slower winds away from the tower would provide relatively less resistance against the other rotors on the turbine as it spun around its central axis. As a result, the VAWT turbine should be much more efficient in a horizontal wind shear environment and should, more importantly, avoid the challenges and inefficiencies faced by a HAWT turbine which cuts perpendicularly through the wind shear turbulence.

In addition, a complementary component that should improve the efficiency, output, and cost of the proposed VAWT turbine is the recent commercialization of permanent magnet generators now being manufactured by multiple companies. These generators allow for a direct connection between a drive shaft and the generator such that complicated and costly gear boxes can be reduced or essentially eliminated. In addition, the smaller sizes of these generators are particularly advantageous to the smaller rotors and higher rotation speeds of an augmented wind power generation system. Taken in concert with the potential benefits of using a continuous variable transmission (“CVT”—currently in operation in millions of cars and trucks) as a variable speed drive interface, as described in U.S. Pat. No. 7,679,207 (Cory), the new generators should help to significantly improve and extend the power curve of a turbine assembly in an augmented wind power generation system—although such benefits are not necessary for the benefits of the current patent to manifest.

The inventions described in U.S. Pat. No. 9,127,646 (Cory) and U.S. Pat. No. 7,679,207 (Cory) provided a significant leap forward in terms of energy density, cost, safety, and environmental impact for large-scale wind power devices. However, more recent engineering studies and sophisticated computer modeling analyses have demonstrated that there are additional, unique, and novel modifications that can be added to those foundational designs to dramatically increase the energy density of a modular amplified wind structure even further while also reducing the wake of the tower and thereby decreasing the amount of land needed for a given capacity wind farm.

The embodiments described herein include novel improvements that have been made to the modular wind amplification tower design that contribute to improved performance both on an individual basis and in terms of the interaction (synergy) between the new features added to the structure. These improvements include, a) adding multiple turbines working in a coordinated sequence to each side of the wind amplification structure, b) adding a fairing to the front of the structure that bisects the oncoming ambient wind flow and adds an additional amplification surface, c) adding multiple vanes before and after the multiple turbine assemblies to serve multiple functions (discussed momentarily), d) adding a vane along the vertical axis inside the circular rotation of the VAWT turbine assembly, and e) positioning the front-most set of turbine assemblies proximal to the front fairing to capitalize on a unique curvilinear wind flow pattern that allows for an increased arc length of lift for a Darrieus-type or similar VAWT turbine thereby substantially increasing the efficiency and output of that turbine assembly.

Multiple Turbines per Side of the Amplification Structure. Increasing the number of turbines per modular level of a wind tower will increase the total capacity of the tower even after adjusting for the efficiency losses of the turbines that are fed by the turbulent wake of antecedent turbines. Unlike horizontal axis wind turbines, VAWTs can have a unique wake flow structure that allows for positioning of VAWT turbines in closer proximity to each other (i.e., in a counter-rotating sequence) to better capture the energy from the wake of an antecedent turbine and therefore greatly decrease the footprint of land needed for a given capacity of wind power (Dabiri, 2011). In an amplified wind structure, however, the shape of the side module wall, the shape of the lower and upper extensions of the wall, the location and shape of intermediate vanes, and the location and shape of a front-facing fairing can more fully manage and optimize the shape, direction, and velocity of the wind stream moving between the VAWTs in sequence. Increasing the number of turbines per module level, plus managing the wind stream to improve the output of the turbines compared to a free-standing configuration, profoundly increases the energy output per module level and, consequentially, the energy production of the larger modular tower.

Front-Facing Fairing. The initial benefit of adding a front-facing fairing is to add a fourth amplification surface to increase the velocity of an ambient wind stream. In the concave portion of a toroidal shape there are already three amplification surfaces—the upper curvilinear roof of the concave opening, the lower curvilinear floor of the concave opening, and the curvilinear side wall of the toroid (which encircles the center axis of the tower). A front-facing fairing is envisioned to also be curvilinear such that the ambient wind flow gains momentum as it moves down either side of the fairing before it would otherwise have impacted the side of the toroidal wall. In addition, a second possible benefit of the fairing is to provide a more efficient transition of the ambient wind flow around the side of the toroid than would have been possible if the original wind flow was allowed to directly impact a more blunt or flattened side wall surface. A third potential benefit of using a curvilinear front-facing fairing is that it creates a curved type of wind flow shape that enables a novel adaptation to the arc length of lift for a VAWT rotor (Described below). Increasing the amplification of the wind flow stream while improving the efficiency of the transition of the wind around the toroidal tower help to improve the overall energy potential of the multi-turbine array.

Multiple Vane Array per Module Level. A great deal of time, engineering, and computer modeling has been focused on introducing wind vanes into the array of VAWTs inside the concave portion of a wind amplification module. The use of vanes in jet airplane engines to optimize the direction, velocities, and back pressures of the wind flows is well-proven science. However, the application of these principles to a sequential, multiple VAWT turbine array on an amplified wind surface structure is novel and an important step forward in improving the energy production of a given wind tower.

There are at least five major potential uses for these wind vanes. The first use involves placing a vane behind the front most turbine assembly. Given the toroidal shape of the module, this vane can be positioned to be impacted by both the more turbulent wake stream that flows from the front turbines as well as a much less turbulent flow of wind that is ambient, i.e., has not been directly impacted by the front turbine assembly. The introduction of the ambient wind flow into the turbulent wake plus the shape and position of the vane in relation to the wall of the module can help to restructure or reorder the combined wind flow thereby improving the potential energy that can be extracted from that wind by the subsequent turbine assemblies. The second use involves the same vane (located behind the front most turbine assembly). In addition to restructuring the combined ambient and turbulent wake wind streams, the vane can be shaped to be slightly curvilinear such that it provides yet another amplification surface. In other words, the combined wind streams can be further amplified in addition to being restructured before they impact the subsequent turbine assemblies. The third use of the vanes is to manage the back pressures that can impact the flow of wind through the array of vanes and turbine assemblies. Specifically, vanes can be configured to create low pressure areas in specific locations around the tower which help draw the wind flow either to or away from certain other locations around the tower. Minimizing back pressures, for example, helps to move the wind flow through the array more easily thereby improving the efficiency and velocity of the wind flow across the rotors of the turbine assemblies. A fourth use of the vanes is to aid with the passive yawing, or rotation, of the integrated set of the fairing, vanes, and turbine assemblies around the outside of the amplification module. In previous patents, the ability of the turbine assemblies to freely rotate around the outside of the tower, like a weather vane passively rotates to face the wind on top of a barn or building, was an important feature that allowed the turbines on each level of the modular tower to independently face the direction of the wind at its specific altitude. In at least one embodiment, vanes can be added to the integrated array of the fairing, vanes, and turbine assemblies to help provide improved force to more efficiently yaw the array around the module. A fifth use of the vanes is to purposefully create smaller vortices, or eddies, from the wake that follows the impact with the various turbine assemblies such that the vortices are outside the silhouette of the module or otherwise reduced in velocity. Purposefully deflecting small portions of the turbulent wind stream helps to reduce the overall wake behind the tower which further improves the ability to locate the towers closer to each other and thereby improve the energy density of the wind farm.

A Vane Along the Center Axis of the VAWT Turbine. In another embodiment, a location for a vane that is unique to a VAWT turbine is along the center axis of the turbine assembly. Especially at slower wind speeds, a significant portion of the wind flow moves through the rotor assembly itself in a manner that provides a minimal contribution to the lift of the rotors. A vane located inside the circular rotation of the VAWT rotors can help to concentrate the wake for an improved velocity of wind across the turbine blades as they enter the strongest “lift” portion of their arc, or help to provide an improved structure to the wake of the turbine. This novel addition to a VAWT turbine assembly is particularly relevant to an amplified wind surface and in situations where the ambient wind is particularly slow. In other words, as the wind velocity increases, the rotational speed of the VAWT rotors increases, and the rotors can exhibit a phenomenon known as “solidification” where the rotors are moving so fast they are perceived by the wind flow to be increasingly solid. When an airstream encounters a solid object it tends to move around the object which would imply that the center vane would deflect decreasing amounts of wind as the RPM of the rotors increase.

Adjustable Vane Angle. To supplement the positioning of the wind vanes both outside and inside the VAWT turbine assemblies, small motors and actuators can be added to each vane to allow for real-time adjustment of the angle of the vanes to the oncoming wind flows thereby allowing for improved optimization of the wind flows under different weather or operating scenarios.

Interaction of VAWT Turbines with a Curvilinear Shaped, Front-Facing Fairing Which Causes a Curved and Slightly Amplified Wind Flow. The conversion efficiency and wake characteristics of VAWT turbines have been studied for many years, but the focus has traditionally been in a normal, “stand alone” wind flow environment where the direction of the incoming wind is essentially a straight line into and through the VAWT rotor diameter. In this traditional situation, Darrieus-type VAWT rotors have a specific period of time—or more accurately, a specific distance of travel, i.e., arc length—where they provide the “lift” forces that propel the rotors around the center, vertical axis. In the current embodiments, the placement of a curvilinear fairing at the front of the wind amplification module creates a unique wind flow pattern that can significantly improve the efficiency of a VAWT turbine. Specifically, if one were to position a VAWT turbine assembly in relatively close proximity to the intersection of the front fairing and the toroidal wall of the amplification module the shape of the wind stream would be curvilinear in shape and the velocity of the wind would be slighty greater than if the wind were in a traditional straight line and not amplified. Positioning the VAWT turbine in a curvilinear wind flow substantially increases the arc length, (i.e., the amount of time the rotor is providing lift to the larger turbine assembly), which should result in an improved efficiency and output from each turbine assembly.

In total, the addition of multiple VAWT turbine assemblies, a front-facing fairing, multiple and adjustable vanes, and the creation of a curvilinear wind stream to increase the arc length of certain VAWT rotors provides numerous novel and important improvements to the energy density and operation of a wind amplification module wind tower. The focus of the embodiments disclosed herein is to present such enhancements.

### SUMMARY

A large-scale, modular, amplified wind power generating system is provided. The wind power generating system includes a shroud or partial shroud wind amplification surface (such as the external wall of a toroidal tower module), a group of two or more VAWT turbines on essentially opposite sides of a toroidal shaped tower or similar amplification surface, one or more fairing type structures with at least one fairing in the center of opposing groups of VAWT turbines with this fairing intended to face the oncoming direction of the ambient wind flow, an optional location for the front VAWT turbines in close proximity to the front fairing such that a unique and extended arc of acceleration (“lift”) for the rotors is created, and a variety of vanes between, behind, and potentially inside the various vertical turbines assemblies to restructure and further amplify the ambient wind stream. Each turbine is connected either directly or through a variable speed drive type interface to electrical generators capable of converting mechanical energy transferred by the rotor assembly into electrical energy. Each set of VAWT turbine/generator assemblies, fairings, and vanes at a given level of a centralized tower or amplification structure may be interconnected onto a yawable frame that enables the combined set of assemblies, fairings, and vanes to freely and passively rotate in unison about the center of the stationary tower or wind amplification shroud.

A method for generating power from wind can be used with an integrated set of VAWT turbine and generator assemblies, fairings, and vanes positioned within a cavity of a plurality of vertically stacked toroidal wind acceleration modules, or adjacent to another shape of wind amplification shroud or partial shroud surface. The method includes positioning the turbines, fairings, and vanes to improve the structure, acceleration, back pressures, and wake vortices of wind flows through the array thereby creating synergistic improvements in system efficiency, energy production, and the length/shape of the tower's wake. The method includes the step of transmitting mechanical energy from a VAWT turbine to an electrical generator located inside, above, beneath, or otherwise adjacent to the VAWT turbine. The method also includes the step of generating electrical energy with the electrical generator which is transmitted to an electrical collection system inside the toroidal tower or an alternatively shaped shroud structure. The VAWT turbine/generator assembly, fairings, and vanes can be mounted to a yawable frame which may sit on a carousel track such that the turbine/generator assembly, fairing, and vanes can freely and passively rotate in unison around the stationary toroidal tower or shroud structure.

Before undertaking the detailed description below, it may be advantageous to set forth definitions of certain words and phrases used in connection to the disclosed exemplary embodiments: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout the present disclosure, those of ordinary skill in the art should understand that in many, if not most instances, such definitions apply to prior, as well as future uses of such defined words and phrases.

### BRIEF DESCRIPTION OF DRAWINGS

For a more complete understanding of the present embodiments and their advantages, reference is now made to the following description taken in conjunction with the accompanying drawings, in which like reference numerals represent like parts:

FIG. 1 illustrates a typical “horizontal wind shear” environment caused by the amplification of ambient wind around an amplification shroud surface, such as a toroidal shaped augmented wind power generation system, in accordance with one of more of the exemplary embodiments.

FIG. 2 depicts a lateral view of how an integrated VAWT turbine, CVT, and generator (“VCG”) assembly might fit within the concave portion of a wind amplification surface such as a toroidal wind module or tower in accordance with one or more of the exemplary embodiments.

FIG. 3A depicts an integrated VCG assembly where the CVT and generator are located beneath the VAWT turbine in accordance with one or more of the exemplary embodiments.

FIG. 3B depicts an integrated VCG assembly where the CVT and generator are located inside a nacelle type enclosure which is located inside the perimeter of the rotors near the central axis in accordance with one or more of the exemplary embodiments.

FIG. 4 depicts a side view of an aggregation of VCG assemblies, fairings, and multiple acceleration vanes arranged within the concave portion of a wind amplification structure such as a toroidal module in accordance with one or more exemplary embodiments.

FIG. 5 depicts a modular amplification wind power generating tower consisting of multiple toroidal modules each with its own set of VCG assemblies, fairings, and acceleration vanes stacked vertically about a central tower or axis in accordance with one or more of the embodiments.

FIG. 6A depicts a top down view of a toroidal wind amplification structure depicting where the front pair of VCG assemblies are located very close to the front central fairing allowing for an extended arc of travel of each individual VAWT rotor blade in a condition of lift or acceleration during its rotation about the vertical axis in accordance with one or more of the embodiments.

FIG. 6B depicts a top down view of a toroidal wind amplification structure depicting where the front pair of VCG assemblies are located substantially downstream of the front central fairing thereby benefitting from the amplified wind stream of the tower but not necessarily from an increased arc of travel as would be the case if it were located immediately adjacent to the fairing in accordance with one or more of the embodiments.

FIG. 7A illustrates curvilinear wind flows that help drive a greater arc of travel of the VAWT rotors within a pair of front VCG assemblies as described in FIG. 6A in accordance with one or more of the embodiments.

FIG. 7B illustrates the amplified wind flows around a toroidal tower when the pair of front VCG assemblies are not sufficiently close to the center fairing to substantially benefit from an increased arc of travel as described in FIG. 6B in accordance with one or more of the embodiments.

FIG. 8 depicts a path of possible wind flows that have been redirected by an acceleration vane that is located between front and aft VCG assemblies in accordance with one or more of the embodiments.

FIG. 9 depicts a pair of ‘aft’ VCG assemblies plus two sets of wind restructuring and grooming vanes located behind the aft VCG assemblies in accordance with one or more of the embodiments.

FIG. 10A illustrates a toroidal shaped wind amplification surface in accordance with one of more of the exemplary embodiments.

FIG. 10B illustrates two forms of an ovoidal shaped wind amplification surface in accordance with one of more of the exemplary embodiments.

FIG. 11 illustrates a top down perspective of two manifestations of a redirection vane located inside the rotational circumference of the vertical axis rotors in accordance with one of more of the exemplary embodiments.

### DETAILED DESCRIPTION OF THE EMBODIMENTS

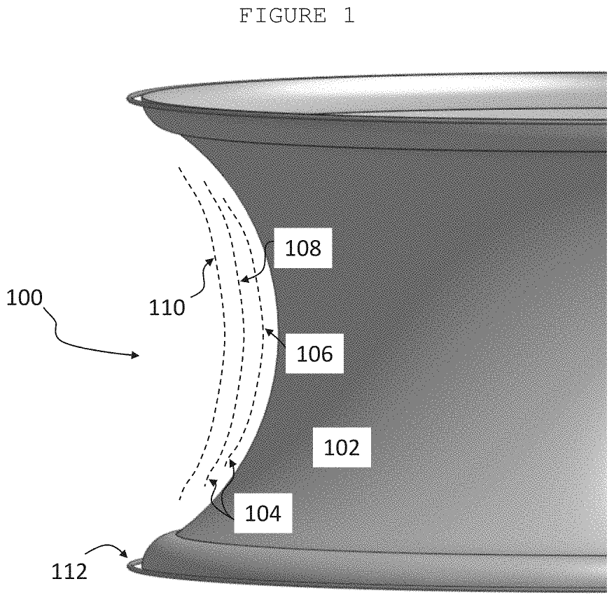

FIGS. 1 through 11, discussed below, and the various descriptions of the embodiments disclosed herein are by way of illustration only and should not be construed as limiting. Those skilled in the art will understand that the principles of the present disclosure may be implemented in a suitably arranged augmented wind power generation system.

The Figures in U.S. Pat. No. 9,127,646 (Cory) illustrated the horizontal wind shear environment created when moving around a wind amplification toroidal structure and a system of stacked modules (levels) that included pairs of VAWT turbines and generators. U.S. Pat. No. 9,127,646 (Cory) and U.S. Pat. No. 7,679,207 (Cory) also illustrated various ways to integrate a VAWT turbine, a variable speed drive (such as continuous variable transmission, “CVT”), and a generator. These illustrations are applicable background for the current patent and can be referred to for additional specificity or embodiments.

FIG. 1 depicts the outside surface a typical amplification shroud 102 (such as a toroidal shaped shroud) and the horizontal wind shear environment 100 created by an augmented wind power system. The fastest winds are located nearest to the tower surface 102. The further one moves away from the tower surface 102, the lower the wind amplification. In FIG. 1, wind flow patterns 104 exist in close proximity to tower surface 102. Previous research suggests that within such a shaped surface, in region 106, wind flow can be approximately 2.16 times faster than the ambient wind speed (Weisbrich & Pucher, 1996). In region 108, wind velocity slows as the distance from the wall increases to approximately 2.0 times faster than the ambient wind speed. In region 110, wind velocity slows more to approximately 1.95 times faster than the ambient wind speed, and so on. As a result, to extract the greatest energy from the amplified wind stream, one embodiment can include blades of the VAWT rotors shaped to conform to the curvilinear shape or profile of the tower wall to access the fastest wind speeds near the tower. To facilitate the rotation of turbines, vanes, and fairings, there can also be located a carousel ring 112 on which the turbines, vanes, and fairings travel around the outside parameter of the shroud wall 102.

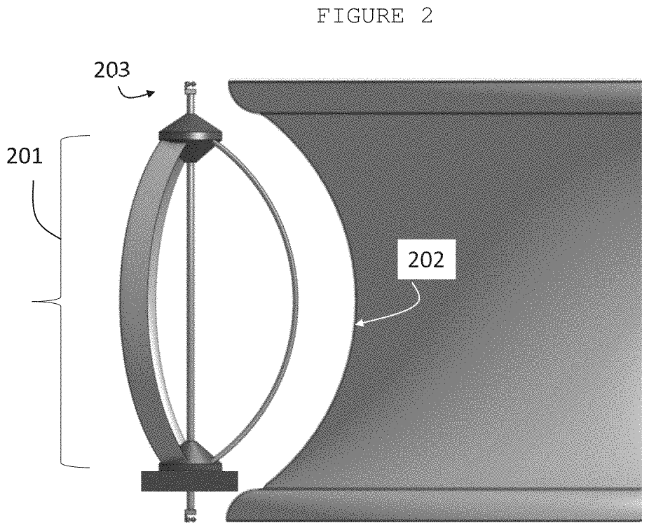

FIG. 2 depicts how a VCG assembly 201, including a set of wheels 203 that allow the VCG to move along the carousel ring into the tower for replacement or repair, fits into the contoured shape of a wind amplification surface such as the outside wall of a toroidal module 202 as described above. The shape of the wall of the toroidal module (or the surface of the amplification structure if not a toroid) can be modified depending on the application. Similarly, the relative height and width of the VAWT rotors on the VCG assembly can also be modified as needed to accommodate a large number of objectives including but not limited to managing torque, power capacity, wind flow turbulence, etc. In combination, the shape of the toroidal surface and the shape of the VAWT rotors are interdependent and should be adjusted and optimized for a particular) application. The exact shape of the amplification surface is not restricted to a toroid nor is the VAWT turbine restricted to a specific ovoidal or spherical shape. In addition, the VAWT turbine can have any number of rotors, struts between the rotors and the axis, or other additions to the VAWT assembly that are appropriate for a specific environment and set of objectives.

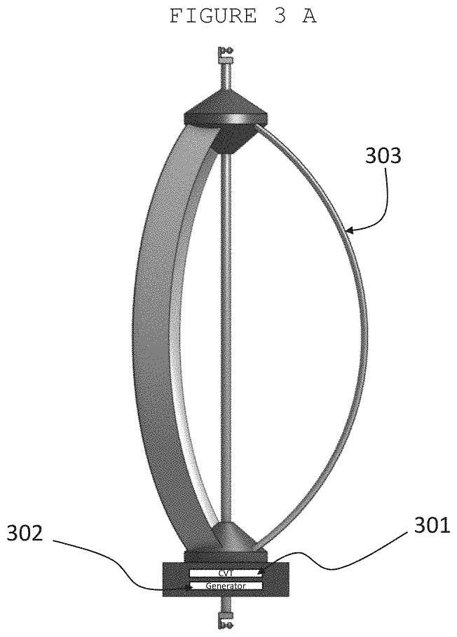

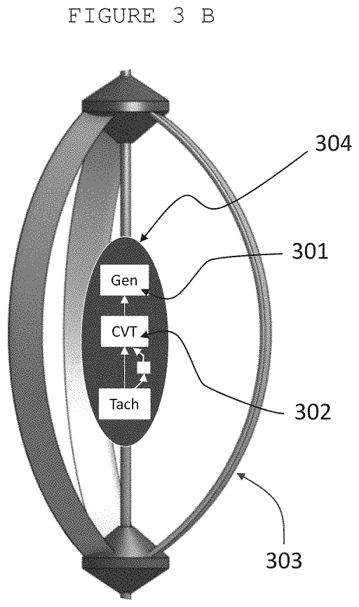

FIG. 3A illustrates an embodiment of a VCG assembly where the CVT 301 and generator 302 are located beneath the VAWT turbine 303. Given the likely size of large utility-scale wind towers, each VAWT rotor could easily exceed 10 meters in height with a proportionate width enabling sufficient room to install a continuously variable transmission and axial permanent magnet stacked beneath the larger rotor assembly.

FIG. 3B illustrates an embodiment of a VCG assembly where the CVT 301 and generator 302 are located inside a nacelle 304 within the perimeter of the rotors along the vertical axis. Although this configuration leaves more vertical space between the modules (or levels) of the amplification tower, the airflow through the VAWT rotors could be impacted and can result in the need to be optimized for the situation. Nonetheless, there may be situations where space constraints and use cases make this the superior configuration.

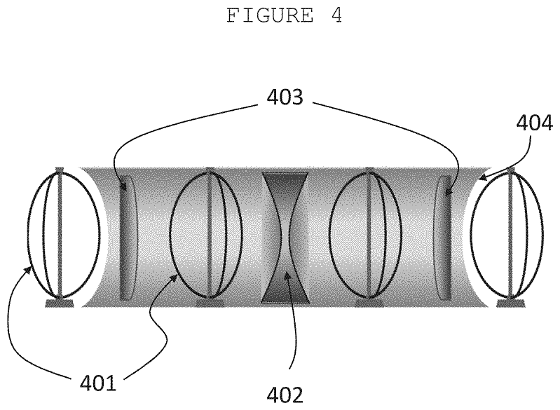

FIG. 4 illustrates a lateral view of an embodiment that includes multiple VCG assemblies 401, a fairing 402, and multiple acceleration vanes 403 located adjacent to the contoured shape of a wind amplification surface 40) such as the outside wall of a toroidal module. One of the implications of this depiction is that the number of VCG assemblies, fairings, vanes, or other wind shaping devices or power conversion assemblies are not limited to one VCG per side of the tower or amplification structure as depicted in previous art. In addition, once multiple assemblies, fairings, and/or vanes are positioned in a given wind stream, the interaction—positive and negative synergies—of the various assemblies and devices can be managed to increase the production of energy and better control downstream wakes in ways that are very valuable and not possible with a single pair VCG assemblies alone. For example, there are a very large number of minor modifications that can be made to any one of the assemblies or devices in the wind stream, e.g., the size, angle, contour, composition, and surface texture of a single wind vane, such that the interaction of the various assemblies and devices are nearly infinite depending on the needs of the user. Having the optionality to optimize the various attributes of the assemblies and devices in the wind stream is a primary source of engineering and economic value for such a system and an important part of the value being created with this patent.

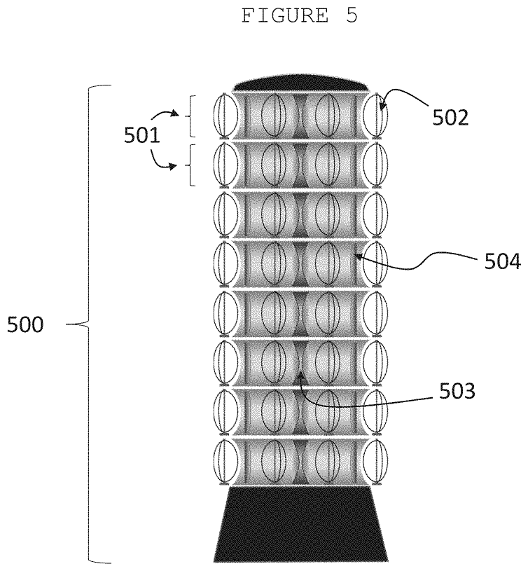

FIG. 5 depicts how individual levels (or modules) 501 that include multiple VCG assemblies 502, fairings 503, and acceleration vanes 504 can be connected to a core internal tower or structure and stacked to form a vertical system 50) of independently operating modules. Although the stacking of toroidal or other wind amplification structures has been described in previous art (e.g., U.S. Pat. No. 9,127,646 (Cory)) the system created by multiple VCG assemblies, fairings, and vanes on a single module can be multiplied across multiple levels to profoundly increase both the capacity, energy density, and operational production of a tower within a fixed footprint. This is important because the footprint of traditional wind farms (the area of land required for a given amount of power generating production) is a significant limitation on both the economics of wind energy as well as the ability to locate wind farms in areas closer to the user of electricity. Alternatively, a single, narrow diameter tower 500 comprised of multiple, high energy density modules, each with independent operation enables the owner/operator to profoundly increase the amount of power generated from a single tower and the number of towers that can be deployed in a wind farm thereby facilitating an exponential increase in energy production from a given wind farm (i.e., a fixed area of real estate). It is this combination of factors that can help large-scale wind power achieve unprecedented levels of production and reductions in costs per megawatt-hour produced.

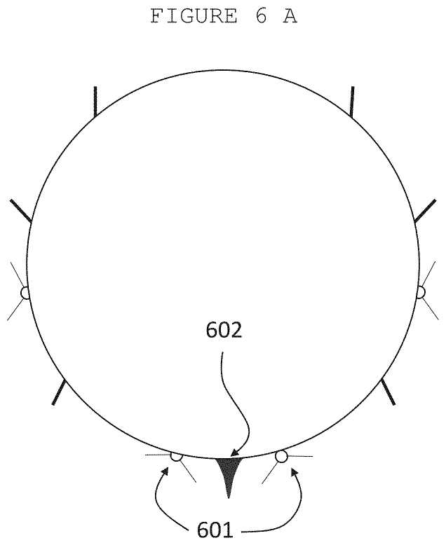

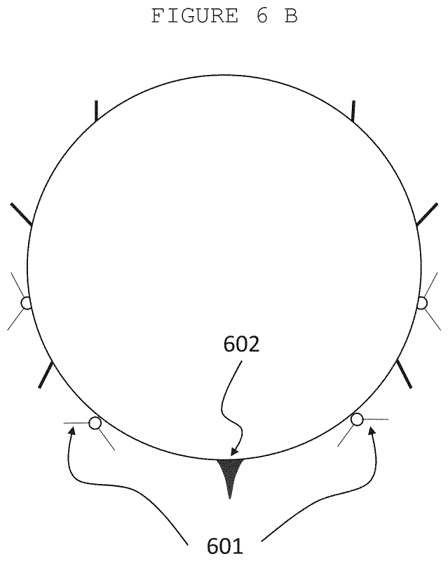

FIG. 6A depicts one embodiment of an array of VCGs, fairing, and acceleration vanes where the front VCGs 601 are located very close to the center fairing 602 to allow the VAWT rotors to benefit from a greater arc of travel through a curved wind stream wherein the period of lift and acceleration of the rotors through the wind stream is substantially longer than what could be realized in a more common straight-line wind scenario. This is a unique wind environment for a VAWT turbine that has not been identified in previous wind power art or commercial application, and the exact benefits of the added propulsion must be rigorously researched. However, it is clear that not only can there be a greater period of lift for each rotor, but if there are sufficient (e.g., four or more) rotor blades on the VAWT turbine then there should be a significant reduction and/or elimination of the normal ‘dynamic stall’ condition that momentarily affects each rotor blade on each of its revolutions. If this brief stall condition can be reduced or eliminated and a subsequent rotor blade can enter the accelerated wind stream before the first rotor blade has finished its extended arc, then the efficiency and power of the VAWT should be improved even further.

FIG. 6B depicts another embodiment of an array of VCGs, fairing, and acceleration vanes where the front VCGs 601 are located substantially downstream of the center fairing 602 thereby benefitting from the amplified wind stream but not necessarily from an increased arc of travel as would be the case if it were located immediately adjacent to the fairing. Although the positioning of a VCG assembly near a fairing would likely lead to an improved rotor efficiency and output, the location also diminishes the amount of time the wind flow stream has to be amplified by the toroidal tower wall. In some circumstances, it would be advantageous to move the front rotors significantly downstream from the fairing to focus on benefiting from the amplified wind stream which should be enhanced by the existence of the fairing, instead of an extended arc of lift.

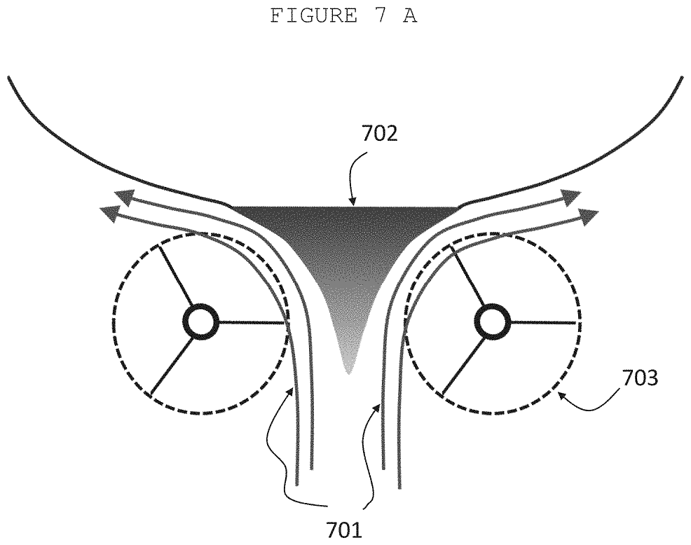

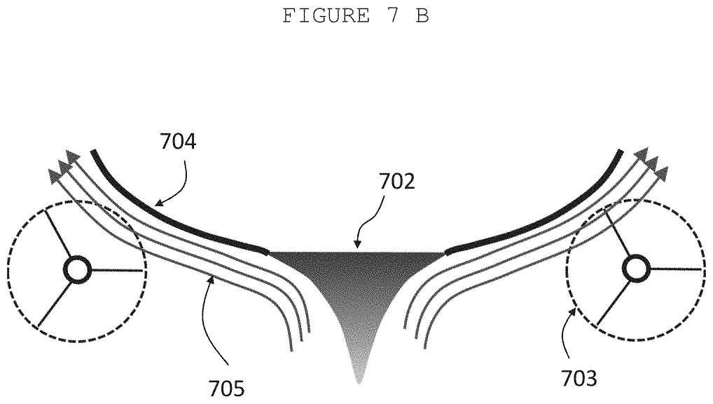

FIG. 7A illustrates a wind stream 701 flow in a curved path along the sides of the fairing 702, creating a unique curvilinear shape that allows for a greater arc of travel for the pair of front VCG assemblies 703 as described in FIG. 6A.

FIG. 7B illustrates the amplified wind flows 705 around a wind amplification surface 704 (such as a toroidal tower) when the pair of front VCG assemblies 703 are not sufficiently close to the center fairing 702 to substantially benefit from an increased arc of travel as described in FIG. 6B. In this scenario, the fairing provides both a more efficient way to initiate the diversion of wind around the tower and more surface area for the wind to be amplified. This results in a smoother and more amplified wind stream.

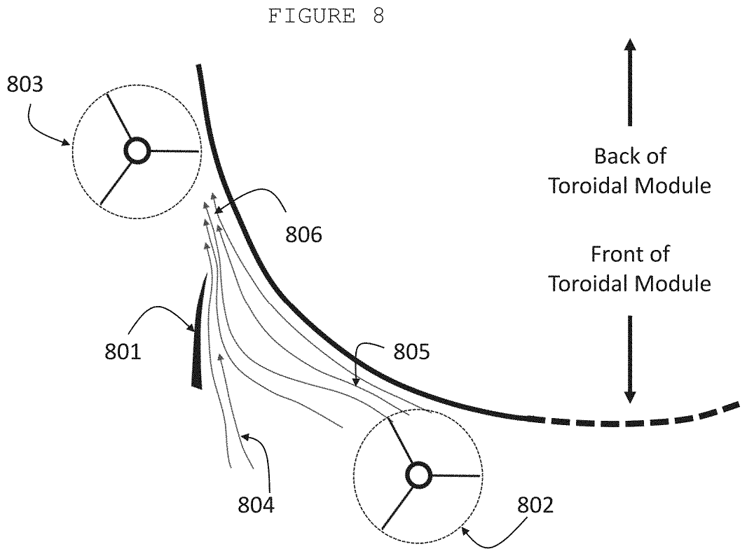

FIG. 8 illustrates an embodiment of an acceleration vane 801 that is located between front 802 and aft 803 VCG assemblies. The illustration depicts the aggregation, grooming, and partial amplification of both an ambient wind flow 804 that has not moved through the diameter of the front VCG assembly and the more turbulent wake of wind 805 that has moved through the front VCG rotors. The system of gathering, grooming, accelerating, and targeting the wind stream towards the rotors of the aft VCG assembly is a synergistic process leading to a wind flow 806 that is more stable and has a higher potential energy capacity which then leads to an improved efficiency and output of the aft VCG assembly.

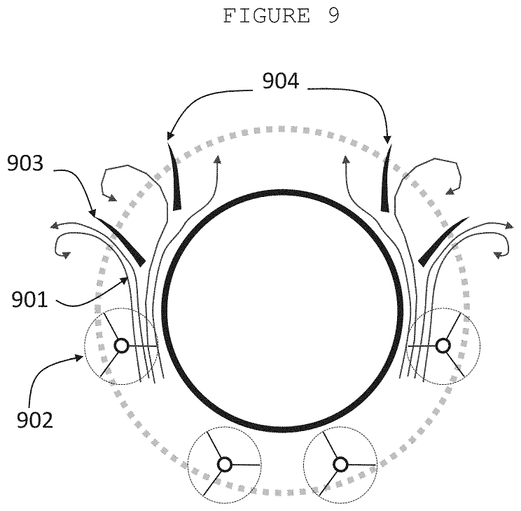

FIG. 9 depicts how a wind stream 901 might move through the aft VCG assembly 902 and either impact a directional vane 903 that would create small vortices/eddies to help reduce and deflect the wake of wind behind the tower, or impact a vane at the back of the module 904 that would act like a tailfin on an airplane and aid in the passive yawing or rotation of the various VCG, fairing, and vane assemblies around the central tower structure similar to a weather vane rotating passively about a central axis.

Most of the present disclosure has focused primarily on a toroidal shaped wind amplification structure, but as alluded to throughout, the system and processes described herein are not intended to be specifically limited to a toroid. Although a toroid is circular from a top and bottom perspective and can better facilitate an easier rotation of the VCG, fairing, and vane equipment around a stationary tower or axis, there are other shapes that can conceivably offer many of the same benefits described by the present disclosure.

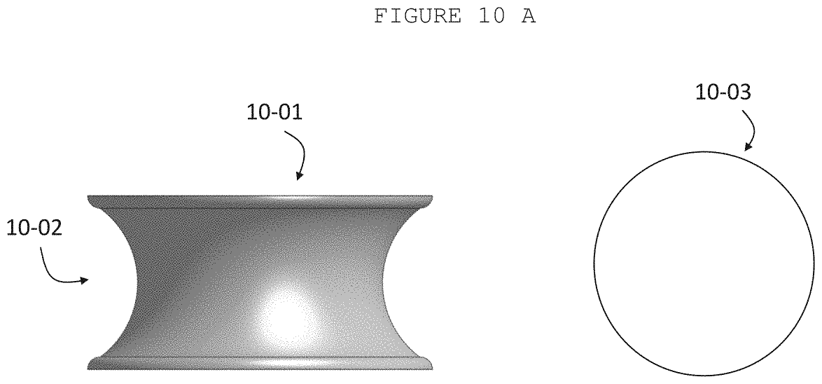

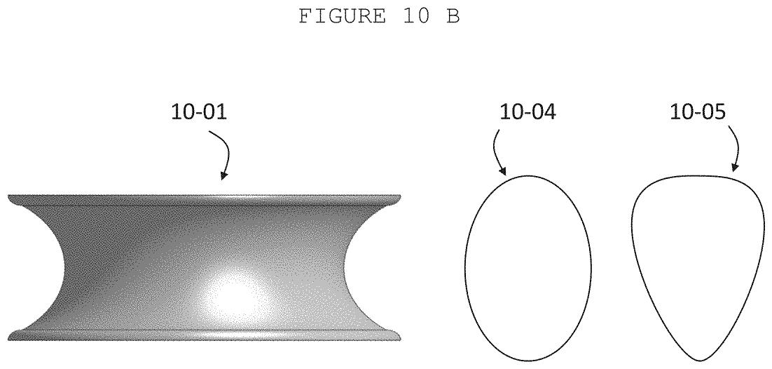

For example, FIG. 10A illustrates a typical toroidal shaped wind amplification structure 10-01 wherein the sides of the toroid are concave 10-02 in orientation and the top of the toroid is essentially circular 10-03. Alternatively, one could elongate the toroid into various forms of an ovoid shape as illustrated in FIG. 10B. One manifestation is more oval in shape when viewed from the top 10-04, while another might be shaped more like an egg or rounded delta from the top 10-05. Although these shapes might force the entire amplification structure to rotate about a central axis instead of just the VCG, fairings, and vanes, many of the benefits of the wind amplification system described herein would still apply. The present disclosure is therefore not explicitly limited exclusively to a true toroidal shaped wind amplification surface.

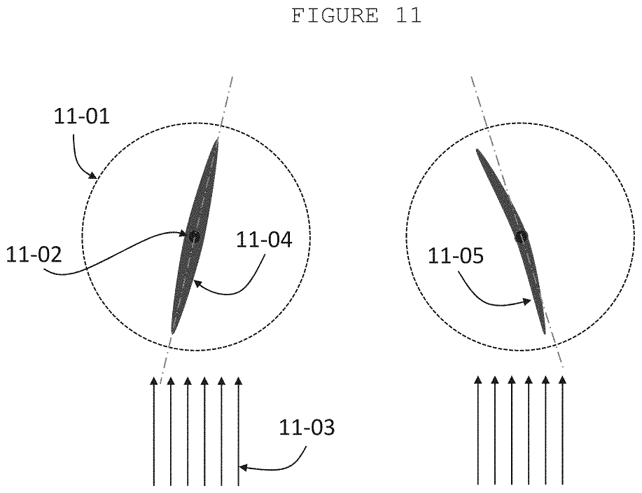

FIG. 11 depicts two embodiments of how the vertical axis inside a VAWT turbine can be shaped into yet another vane to further enhance the structuring, amplification, or back pressure management of the airflow around an amplification tower or structure. Specifically, it was illustrated in FIG. 3B that there may be situations where it is advantageous to make the center axis 3-04 of a VAWT turbine 11-01 wider to house various configurations of generation, CVT, and/or monitoring equipment. This basic concept can be expanded to further change the shape of the center axis 11-02 into either a symmetrical vane 11-04 or a curvilinear vane 11-05 to provide different types of refinements to the airflow pattern 11-03. This adaptation is particularly important at lower wind flow velocities when the turbine is spinning at a sufficiently low RPM that a substantial amount of wind is still passing through the center area of the turbine. For VAWT turbines that have more than three rotor blades, the faster they spin, the more they are perceived to be “solid” by the wind flow which then automatically and passively deflects around the outside of the turbine. This phenomenon, known as “solidity,” is an important feature of multi-bladed VAWT turbines because it helps to reduce overspinning and bleeds off excess energy which, in turn, helps to protect the turbine in higher wind speeds. The internal vane is, therefore, more effective when wind flows are slower and the need for increased restructuring and amplification is greater.

Although the present disclosure has been described by various embodiments, various other changes and modifications are also contemplated. It is intended that the present disclosure encompass such changes and modifications as fall within the scope of the appended claims.

### ADDITIONAL DESCRIPTION

The following clauses are offered as further description of the disclosed invention.
Clause 1. A wind power generating system, comprising:

a plurality of vertical axis wind turbine assemblies;

a plurality of vertically stacked wind amplification modules, including at least one toroidal shaped module;

a plurality of adjustable wind vanes;

at least one fairing positioned in the middle and front of the plurality of vertical axis wind turbine assemblies to bisect a wind stream to allow the wind stream to flow across the sides of at least one of the plurality of vertically stacked wind amplification module; and

wherein at least one of the plurality of vertical axis wind turbine rotor assemblies, vanes, and fairing is located in a cavity formed by a curvilinear surface of one or more of the wind amplification modules.
Clause 2. The wind power generating system of any preceding or proceeding claim wherein the plurality of adjustable wind vanes are positioned between the plurality of vertical axis wind turbine assemblies.
Clause 3. The wind power generating system of any preceding or proceeding claim wherein the plurality of adjustable wind vanes are positioned behind the plurality of vertical axis wind turbine assemblies.
Clause 4. The wind power generating system of any preceding or proceeding claim further comprising a generator assembly located beneath, above, or within the spinning trajectory of rotors of each of the plurality of vertical axis wind turbine rotor assemblies.
Clause 5. The wind power generating system of any preceding or proceeding claim further comprising:

a continuously variable transmission coupled to the at least one of the plurality of vertical axis wind turbine rotor assemblies;

a sensor coupled to at least one of the plurality of vertical axis wind turbine rotor assemblies; and

a controller electrically coupled to the sensor and to the continuously variable transmission,

wherein the generator assembly is mechanically coupled to the continuously variable transmission.
Clause 6. The wind power generating system of any preceding or proceeding claim further comprising a wind vane positioned along a vertical center axis inside a rotational trajectory of rotors of one or more of the vertical axis wind turbine assemblies.
Clause 7. The wind power generating system of any preceding or proceeding claim further comprising one or more rotor blades within each of the plurality of vertical axis wind turbine rotor assemblies,

wherein the one or more rotor blades each has an edge substantially conforming to a curvilinear contour of the cavity.
Clause 8. The wind power generating system of any preceding or proceeding claim further comprising:

a tower comprised of a stacked set of wind amplification modules; and

stationary carousel tracks outside of each of the plurality of amplification modules securely fixed to a top and a bottom of the wind amplification module.
Clause 9. The wind power generating system of any preceding or proceeding claim further comprising a yawable frame assembly that connects together a set of the fairing, vertical axis wind turbine assemblies, and wind vanes per module level.
Clause 10. The wind power generating system of any preceding or proceeding claim further comprising one or more sets of rollers fixed to the yawable frame that connects together a top and a bottom of the fairing, vertical axis wind turbines assemblies, and wind vane assemblies,

wherein the rollers are connected to both a top and a bottom of a stationary carousel track.
Clause 11. The wind power generating system of any preceding or proceeding claim further comprising one or more sets of rollers fixed to a cluster of components including the vertical axis wind turbine assembly, the continuously variable transmission, and the generator assembly such that the cluster can be moved onto and off of the yawable frame assembly.
Clause 12. The wind power generating system of any preceding or proceeding claim further comprising an actuator and a motor connected to each of the adjustable wind vanes on each of the plurality of modules.
Clause 13. The wind power generating system of any preceding or proceeding claim further comprising an actuator and motor connected to each of the wind vanes located along the center axis inside the trajectory of the vertical axis wind turbine rotors.
Clause 14. A method for generating electrical power from wind, comprising the steps of:

transmitting mechanical energy from a vertical axis wind turbine rotor assembly located adjacent to a vertically stacked wind acceleration module to an electrical generator, and

transmitting electrical energy output from the electrical generator through a wire in a yawable frame that connects a plurality of fairings, vertical axis wind turbines, and vanes on each of the vertically stacked wind acceleration modules into an interior core of an acceleration module tower.
Clause 15. The method of any preceding or proceeding claim, further comprising:

moving the yawable frame that connects the plurality of fairings, vertical axis wind turbine rotor assemblies, and wind vanes along a path concentric with an axis of symmetry of the module,

wherein the vertically stacked wind acceleration modules are substantially symmetrical about a vertical axis.
Clause 16. The method of any preceding or proceeding claim, further comprising preventing transmission of mechanical energy from the vertical axis wind turbine rotor assembly to the electrical generator according to a sensed rotational speed.
Clause 17. The method of any preceding or proceeding claim, further comprising:

sensing a rotational speed of the transmission input and a transmission output;

varying a ratio of the rotational speed of a transmission input to the rotational speed of a transmission output over a continuous range of values:

determining a range of rotational velocities; and

controlling a continuously variable transmission such that the electrical generator operates within the range of rotational velocities, the range of rotational velocities being based upon a signal received from a sensor.
Clause 18. The method of any preceding or proceeding claim, further comprising positioning at least one of the plurality of fairings to bisect ambient airflow to begin wind amplification, aid in passive rotation of the yawable frame that connects the at last one of the plurality of fairings, vertical axis wind turbines, and vanes, and provide an increased arc of lift for one or more vertical axis wind turbines located near the at least one of the plurality of fairings.
Clause 19. The method of any preceding or proceeding claim, further comprising positioning the vanes in front of the vertical axis wind turbine assemblies to restructure turbulent wind streams, increase amplification of wind streams, manage back pressures to enhance wind flow through the vertical axis wind turbine assemblies, and aid in passive rotation of the yawable frame that connects the fairing, vertical axis wind turbines, and vanes.
Clause 20. The method of any preceding or proceeding claim, further comprising positioning the vanes behind the vertical axis wind turbine assemblies to restructure turbulent wind streams, increase amplification of wind streams, manage back pressures to enhance wind flow through the vertical axis wind turbine assemblies, and aid in passive rotation of the yawable frame that connects the fairing, vertical axis wind turbines, and vanes.
Clause 21. The method of any preceding or proceeding claim, further comprising using actuators and motors to adjust an angle of each vane in relation to a direction of incoming airflow to alter the interaction of the vane with the airflow.
Clause 22. The method of any preceding or proceeding claim, further comprising using actuators and motors to adjust an angle of each vane located inside a trajectory of the rotors of the vertical axis wind turbines in relation to a direction of the incoming airflow to alter the interaction of the vane with the airflow to enhance the output of one or more of the vertical axis wind turbines.
Clause 23. The method of any preceding or proceeding claim, further comprising repositioning a cluster of components including the vertical axis wind turbine assembly, the continuously variable transmission, and the generator assembly onto and off of the yawable frame assembly for inspection, repair, and/or replacement of the cluster.
Clause 24. A wind turbine power generation apparatus, comprising:

a first vertical axis wind turbine rotor assembly;

a plurality of blades within the first vertical axis wind turbine rotor assembly shaped to substantially conform to a contour of a wind acceleration module;

a generator assembly located beneath, above, or within a spherical trajectory of the first vertical axis wind turbine rotor blades; and

a set of rollers affixed to a top and a bottom of the first vertical axis wind turbine assembly for moving the assembly off and onto a first yawable frame assembly.
Clause 25. The wind turbine power generation apparatus of any preceding or proceeding claim, further comprising:

a continuously variable transmission mechanically coupled to the first vertical axis wind turbine rotor assembly;

an electrical generator mechanically coupled to one of the continuously variable transmission and the first vertical axis wind turbine rotor assembly;

a sensor coupled to the first vertical axis wind turbine rotor assembly; and

a controller electrically coupled to the sensor and to the continuously variable transmission, wherein the electrical generator is mechanically coupled to the continuously variable transmission,

wherein the electrical generator is configured to convert mechanical energy transferred by one of the continuously variable transmission or the first vertical axis wind turbine rotor assembly into electrical energy.
Clause 26. The wind turbine power generation apparatus of any preceding or proceeding claim, further comprising:

an adjustable vane located along a center axis inside the trajectory of the rotors of the vertical axis wind turbine; and

at least one actuator and motor to adjust an angle of each vane located inside the trajectory of the rotors of the vertical axis wind turbines in relation to a direction of incoming airflow;
Clause 27. The wind turbine power generation apparatus of any preceding or proceeding claim, further comprising:

a frame that connects together a plurality of fairings, vertical axis wind turbine assemblies, and vanes;

a plurality of rollers affixed to the frame to allow it to move along a stationary set of tracks affixed to the outside of a wind amplification module.
Clause 28. A wind turbine power generation apparatus of any preceding or proceeding claim further comprising electrical wires associated with the first yawable frame assembly of the fairing, vertical axis wind turbines, and wind vanes through which electrical energy output from the generator assembly is transmitted into the interior tower core.
Clause 29. The wind turbine power generation apparatus of any preceding or proceeding claim, wherein the first yawable frame connecting the fairing, vertical axis wind turbine assemblies, and the wind vanes moves all of the connected wind vanes, vertical axis wind turbine assemblies, and fairings simultaneously from a first position to a second position.
Clause 30. The wind turbine power generation apparatus of any preceding or proceeding claim, wherein the first yawable frame assembly is mounted to operate independently from a second yawable frame assembly located in the concavity formed by the curvilinear surface of the wind amplification modules above or below the first yawable frame assembly.

1. A wind power generating system, comprising:
a plurality of vertical axis wind turbine assemblies;
a plurality of vertically stacked wind amplification modules, including at least one toroidal shaped module;
a plurality of adjustable wind vanes; and
at least one fairing positioned in the middle and front of the plurality of vertical axis wind turbine assemblies to bisect a wind stream to allow the wind stream to flow across the sides of at least one of the plurality of vertically stacked wind amplification module,
wherein at least one of the plurality of vertical axis wind turbine rotor assemblies, vanes, and fairing is located in a cavity formed by a curvilinear surface of one or more of the wind amplification modules,
wherein the plurality of adjustable wind vanes are positioned between the plurality of vertical axis wind turbine assemblies.

2. (canceled)

3. The wind power generating system of claim 1, wherein the plurality of adjustable wind vanes are positioned behind the plurality of vertical axis wind turbine assemblies.

4. The wind power generating system of claim 1, further comprising a generator assembly located beneath, above, or within the spinning trajectory of rotors of each of the plurality of vertical axis wind turbine rotor assemblies.

5. The wind power generating system of claim 4, further comprising:
a continuously variable transmission coupled to the at least one of the plurality of vertical axis wind turbine rotor assemblies;
a sensor coupled to at least one of the plurality of vertical axis wind turbine rotor assemblies; and
a controller electrically coupled to the sensor and to the continuously variable transmission, wherein the generator assembly is mechanically coupled to the continuously variable transmission.

6. The wind power generating system of claim 1, further comprising a wind vane positioned along a vertical center axis inside a rotational trajectory of rotors of one or more of the vertical axis wind turbine assemblies.

7. The wind power generating system of claim 1, further comprising one or more rotor blades within each of the plurality of vertical axis wind turbine rotor assemblies,
wherein the one or more rotor blades each has an edge substantially conforming to a curvilinear contour of the cavity.

8. The wind power generating system of claim 1, further comprising:
a tower comprised of a stacked set of wind amplification modules; and
stationary carousel tracks outside of each of the plurality of amplification modules securely fixed to a top and a bottom of the wind amplification module.

9. The wind power generating system of claim 1, further comprising a yawable frame assembly that connects together a set of the fairing, vertical axis wind turbine assemblies, and wind vanes per module level.

10. The wind power generating system of claim 9, further comprising one or more sets of rollers fixed to the yawable frame that connects together a top and a bottom of the fairing, vertical axis wind turbines assemblies, and wind vane assemblies,
wherein the rollers are connected to both a top and a bottom of a stationary carousel track.

11. The wind power generating system of claim 9, further comprising one or more sets of rollers fixed to a cluster of components including the vertical axis wind turbine assembly, the continuously variable transmission, and the generator assembly such that the cluster can be moved onto and off of the yawable frame assembly.

12. The wind power generating system of claim 9, further comprising an actuator and a motor connected to each of the adjustable wind vanes on each of the plurality of modules.

13. The wind power generating system of claim 6, further comprising an actuator and motor connected to each of the wind vanes located along the center axis inside the trajectory of the vertical axis wind turbine rotors.

14. A method for generating electrical power from wind, comprising the steps of:
transmitting mechanical energy from a vertical axis wind turbine rotor assembly located adjacent to a vertically stacked wind acceleration module to an electrical generator, and
transmitting electrical energy output from the electrical generator through a wire in a yawable frame that connects a plurality of fairings, vertical axis wind turbines, and vanes on each of the vertically stacked wind acceleration modules into an interior core of an acceleration module tower.

15. The method of claim 14, further comprising:
moving the yawable frame that connects the plurality of fairings, vertical axis wind turbine rotor assemblies, and wind vanes along a path concentric with an axis of symmetry of the module,
wherein the vertically stacked wind acceleration modules are substantially symmetrical about a vertical axis.

16. The method of claim 14, further comprising preventing transmission of mechanical energy from the vertical axis wind turbine rotor assembly to the electrical generator according to a sensed rotational speed.

17. The method of claim 14, further comprising:
sensing a rotational speed of the transmission input and a transmission output;
varying a ratio of the rotational speed of a transmission input to the rotational speed of a transmission output over a continuous range of values:
determining a range of rotational velocities; and
controlling a continuously variable transmission such that the electrical generator operates within the range of rotational velocities, the range of rotational velocities being based upon a signal received from a sensor.

18. The method of claim 14, further comprising positioning at least one of the plurality of fairings to bisect ambient airflow to begin wind amplification, aid in passive rotation of the yawable frame that connects the at last one of the plurality of fairings, vertical axis wind turbines, and vanes, and provide an increased arc of lift for one or more vertical axis wind turbines located near the at least one of the plurality of fairings.

19. The method of claim 14, further comprising positioning the vanes in front of the vertical axis wind turbine assemblies to restructure turbulent wind streams, increase amplification of wind streams, manage back pressures to enhance wind flow through the vertical axis wind turbine assemblies, and aid in passive rotation of the yawable frame that connects the fairing, vertical axis wind turbines, and vanes.

20. The method of claim 14, further comprising positioning the vanes behind the vertical axis wind turbine assemblies to restructure turbulent wind streams, increase amplification of wind streams, manage back pressures to enhance wind flow through the vertical axis wind turbine assemblies, and aid in passive rotation of the yawable frame that connects the fairing, vertical axis wind turbines, and vanes.

21. The method of claim 19, further comprising using actuators and motors to adjust an angle of each vane in relation to a direction of incoming airflow to alter the interaction of the vane with the airflow.

22. The method of claim 14, further comprising using actuators and motors to adjust an angle of each vane located inside a trajectory of the rotors of the vertical axis wind turbines in relation to a direction of the incoming airflow to alter the interaction of the vane with the airflow to enhance the output of one or more of the vertical axis wind turbines.

23. The method of claim 14, further comprising repositioning a cluster of components including the vertical axis wind turbine assembly, the continuously variable transmission, and the generator assembly onto and off of the yawable frame assembly for inspection, repair, and/or replacement of the cluster.

24. A wind turbine power generation apparatus, comprising:
a first vertical axis wind turbine rotor assembly;
a plurality of blades within the first vertical axis wind turbine rotor assembly shaped to substantially conform to a contour of a wind acceleration module;
a generator assembly located beneath, above, or within a spherical trajectory of the first vertical axis wind turbine rotor blades; and
a set of rollers affixed to a top and a bottom of the first vertical axis wind turbine assembly for moving the assembly off and onto a first yawable frame assembly.

25. The wind turbine power generation apparatus of claim 24, further comprising:
a continuously variable transmission mechanically coupled to the first vertical axis wind turbine rotor assembly;
an electrical generator mechanically coupled to one of the continuously variable transmission and the first vertical axis wind turbine rotor assembly;
a sensor coupled to the first vertical axis wind turbine rotor assembly; and
a controller electrically coupled to the sensor and to the continuously variable transmission, wherein the electrical generator is mechanically coupled to the continuously variable transmission,
wherein the electrical generator is configured to convert mechanical energy transferred by one of the continuously variable transmission or the first vertical axis wind turbine rotor assembly into electrical energy.

26. The wind turbine power generation apparatus of claim 24, further comprising:
an adjustable vane located along a center axis inside the trajectory of the rotors of the vertical axis wind turbine; and
at least one actuator and motor to adjust an angle of each vane located inside the trajectory of the rotors of the vertical axis wind turbines in relation to a direction of incoming airflow;

27. The wind turbine power generation apparatus of claim 24, further comprising:
a frame that connects together a plurality of fairings, vertical axis wind turbine assemblies, and vanes;
a plurality of rollers affixed to the frame to allow it to move along a stationary set of tracks affixed to the outside of a wind amplification module.

28. A wind turbine power generation apparatus of claim 27 further comprising electrical wires associated with the first yawable frame assembly of the fairing, vertical axis wind turbines, and wind vanes through which electrical energy output from the generator assembly is transmitted into the interior tower core.

29. The wind turbine power generation apparatus of claim 27, wherein the first yawable frame connecting the fairing, vertical axis wind turbine assemblies, and the wind vanes moves all of the connected wind vanes, vertical axis wind turbine assemblies, and fairings simultaneously from a first position to a second position.

30. The wind turbine power generation apparatus of claim 27, wherein the first yawable frame assembly is mounted to operate independently from a second yawable frame assembly located in the concavity formed by the curvilinear surface of the wind amplification modules above or below the first yawable frame assembly.

31. The wind power generating system of claim 1, wherein the at least one toroidal shaped module is round, ovoidal, or triangular from a perspective above a wind amplification module tower.
